(19) United States
(12) Patent Application Publication
(10) Pub. No.: US 2026/0258181 A1
(43) Pub. Date: Sep. 3, 2026

(54) CROSSLINKABLE ELASTOMERIC COMPOSITIONS INCLUDING SUSTAINABLE CONTENT, ARTICLES MADE THEREFROM, AND METHODS OF MAKING THE SAME

(71) Applicant: Avient Corporation, Avon Lake, OH (US)

(72) Inventor: Liang Xu, Vernon Hills, IL (US)

(73) Assignee: Avient Corporation, Avon Lake, OH (US)

(21) Appl. No.: 19/164,840

(22) PCT Filed: Mar. 12, 2024
(86) PCT No.: PCT/US2024/019605

§ 371 Date: Sep. 12, 2025

Related U.S. Application Data
(60) Provisional application No. 63/452,426, filed on Mar. 15, 2023.

(51) Int. Cl. C08F 255/04; C08L 51/06

(52) U.S. Cl. CPC C08F 255/04; C08L 51/06; C08F 2810/20; C08L 2205/03; C08L 2207/04; C08L 2207/062

(57) ABSTRACT

A crosslinkable material includes 10 wt. % to 80 wt. % of a silane-grafted ethylene-based elastomer, 10 wt. % to 80 wt. % of a silane-grafted propylene-based elastomer, and 10 wt. % to 40 wt. % of a silane-grafted polyethylene homopolymer, based on a total weight of the crosslinkable polymer material. In various embodiments, a crosslinkable silane-grafted polyolefin composition including the silane-grafted ethylene-based elastomer, the silane-grafted propylene-based elastomer, and the silane-grafted polyethylene homopolymer is formed by reacting an ethylene-based elastomer, a propylene-based elastomer, a polyethylene homopolymer, a vinyl silane, and an organic peroxide. Also provided is a crosslinkable thermoplastic composition including the reaction product of the crosslinkable material with 0.5 wt. % to 8 wt. % of a crosslinking catalyst, based on a total weight of the crosslinkable thermoplastic composition. According to some embodiments, cured articles formed from the crosslinkable thermoplastic composition are thermoset articles, having excellent compression set properties.

### CLAIM OF PRIORITY

This application claims the benefit of U.S. Provisional Patent Application Ser. No. 63/452,426 bearing Attorney Docket Number 1202304 and filed on Mar. 15, 2023, which is hereby incorporated by reference in its entirety.

### FIELD

The present disclosure relates to elastomeric materials and, more particularly, to thermoplastic elastomeric compositions that are moisture curable.

### BACKGROUND

Elastomeric compositions are used in a variety of markets and product applications, including building and construction, automotive and transportation, consumer products, and healthcare applications, to name a few. Although thermoset elastomers can provide desirable properties for the final application, processes for making conventional thermoset elastomers typically utilize significant amounts of time and energy. Accordingly, there remains a need for alternative crosslinkable elastomeric compositions and methods of making the same.

### SUMMARY

The following is a brief summary of subject matter that is described in greater detail herein. This summary is not intended to be limiting as to the scope of the claims.

According to a first aspect of the present disclosure, a crosslinkable material is provided. The crosslinkable material comprises 10 wt. % to 80 wt. % of a silane-grafted ethylene-based elastomer, based on a total weight of the crosslinkable polymer material; 10 wt. % to 80 wt. % of a silane-grafted propylene-based elastomer, based on a total weight of the crosslinkable polymer material; and 10 wt. % to 40 wt. % of a silane-grafted polyethylene homopolymer, based on a total weight of the crosslinkable polymer material.

In a second aspect, a crosslinkable material comprises the crosslinkable material according to the previous aspect, wherein the silane-grafted ethylene-based elastomer is formed from an ethylene-alpha olefin copolymer.

In a third aspect, a crosslinkable material comprises the crosslinkable material according to any one of the previous aspects, wherein the silane-grafted ethylene-based elastomer is formed from an ethylene-based elastomer having a density of from 0.86 g/cm³ to 0.90 g/cm³.

In a fourth aspect, a crosslinkable material comprises the crosslinkable material according to any one of the previous aspects, wherein the silane-grafted propylene-based elastomer is formed from a propylene-alpha olefin copolymer.

In a fifth aspect, a crosslinkable material comprises the crosslinkable material according to any one of the previous aspects, wherein the silane-grafted propylene-based elastomer is formed from a propylene-based elastomer having a density of from 0.85 g/cm³ to 0.90 g/cm³.

In a sixth aspect, a crosslinkable material comprises the crosslinkable material according to any one of the previous aspects, wherein the silane-grafted polyethylene homopolymer is formed from a polyethylene homopolymer having a weight average molecular weight of from 10,000 g/mol to 500,000 g/mol.

In a seventh aspect, a crosslinkable material comprises the crosslinkable material according to any one of the previous aspects, wherein the silane-grafted polyethylene homopolymer is formed from a polyethylene homopolymer having a percent crystallinity of greater than 40%.

In an eighth aspect, a crosslinkable material comprises the crosslinkable material according to any one of the previous aspects, wherein the silane-grafted polyethylene homopolymer is formed from a recycled polyethylene homopolymer.

In a ninth aspect, a crosslinkable material comprises the crosslinkable material according to any one of the previous aspects, wherein the crosslinkable polymer material has a hardness of 50 Shore A to 50 Shore D.

In a tenth aspect, a crosslinkable material comprises the crosslinkable material according to any one of the previous aspects, wherein the silane-grafted ethylene-based elastomer, the silane-grafted propylene-based elastomer, and the silane-grafted polyethylene homopolymer are prepared by reacting an ethylene-based elastomer, a propylene-based elastomer, and a polyethylene homopolymer with a vinyl silane and an organic peroxide.

In an eleventh aspect, a crosslinkable material comprises the crosslinkable material according to the tenth aspect, wherein the organic peroxide is selected from the group consisting of di-t-butyl peroxide; t-butyl cumyl peroxide; dicumyl peroxide; 1,3-bis(t-butylperoxyisopropyl)benzene, n-butyl-4,4-bis(t-butyl-peroxy) valerate; benzoyl peroxide; 2,5-bis(t-butylperoxy)-2,5-dimethylhexyne-3; cumyl hydroperoxide; t-butyleperoxy isopropyl carbonate; t-butylperbenzoate; bis(2-methylbenzoyl) peroxide; bis(4-methylbenzoyl) peroxide; t-butyl peroctoate; methyl ethyl ketone peroxide; lauryl peroxide; tert-butyl peracetate; di-t-amyl peroxide; t-amyl peroxybenzoate; 1,1-bis(t-butylperoxy)-3,3,5-trimethylcyclohexane; 2,5-bis(t-butylperoxy)-2,5 dimethyl hexane; 2,4-dichlorobenzoyl peroxide; and combinations thereof.

In a twelfth aspect, a crosslinkable material comprises the crosslinkable material according to the tenth or eleventh aspects, wherein the vinyl silane includes a vinyl group and at least one —OR group, where each R is individually a monovalent hydrocarbon group that has from 1 to 12 carbon atoms.

In a thirteenth aspect, a crosslinkable material comprises the crosslinkable material according to any one of the tenth through twelfth aspects, wherein the vinyl silane is present in an amount of from 0.5 wt. % to 5 wt. %, based on the total weight of the crosslinkable polymer material.

In a fourteenth aspect, a crosslinkable material comprises the crosslinkable material according to any one of the tenth through thirteenth aspects, wherein the organic peroxide is present in an amount of from 0.05 wt. % to 1.5 wt. %, based on the total weight of the crosslinkable polymer material.

In a fifteenth aspect, a crosslinkable material comprises the crosslinkable material according to any one of the previous aspects, wherein the silane-grafted ethylene-based elastomer, the silane-grafted propylene-based elastomer, and the silane-grafted polyethylene homopolymer each comprise a silane moiety having a functional group capable of crosslinking the corresponding silane-grafted ethylene-based elastomer, silane-grafted propylene-based elastomer, and silane-grafted polyethylene homopolymer in the presence of a moisture-cure crosslinking catalyst.

According to a sixteenth aspect, a crosslinkable thermoplastic composition is provided. The crosslinkable thermoplastic composition comprises the reaction product of: 10 wt. % to 80 wt. % of a silane-grafted ethylene-based elastomer, based on a total weight of the crosslinkable thermoplastic composition; 10 wt. % to 80 wt. % of a silane-grafted propylene-based elastomer, based on a total weight of the crosslinkable thermoplastic composition; 10 wt. % to 40 wt. % of a silane-grafted polyethylene homopolymer, based on a total weight of the crosslinkable thermoplastic composition; and 0.5 wt. % to 8 wt. % of a crosslinking catalyst, based on a total weight of the crosslinkable thermoplastic composition.

In a seventeenth aspect, a crosslinkable thermoplastic composition comprises the crosslinkable thermoplastic composition according to the sixteenth aspect, wherein the crosslinking catalyst comprises an organic base, a carboxylic acid, a metallic stearate, an organometallic compound, or a combination thereof.

In an eighteenth aspect, a crosslinkable thermoplastic composition comprises the crosslinkable thermoplastic composition according to the sixteenth or seventeenth aspects, wherein the crosslinkable thermoplastic composition has a Shore A hardness of from 50 to 100 after curing.

In a nineteenth aspect, a crosslinkable thermoplastic composition comprises the crosslinkable thermoplastic composition according to any one of the sixteenth through eighteenth aspects, wherein the crosslinkable thermoplastic composition has a compression set of 5% to 50% at 150° C. after curing.

In a twentieth aspect, a crosslinkable thermoplastic composition comprises the crosslinkable thermoplastic composition according to any one of the sixteenth through nineteenth aspects, wherein the silane-grafted ethylene-based elastomer is formed from an ethylene-alpha olefin copolymer.

In a twenty-first aspect, a crosslinkable thermoplastic composition comprises the crosslinkable thermoplastic composition according to any one of the sixteenth through twentieth aspects, wherein the silane-grafted ethylene-based elastomer is formed from an ethylene-based elastomer having a density of from 0.86 g/cm³ to 0.90 g/cm³.

In a twenty-second aspect, a crosslinkable thermoplastic composition comprises the crosslinkable thermoplastic composition according to any one of the sixteenth through twenty-first aspects, wherein the silane-grafted propylene-based elastomer is formed from a propylene-alpha olefin copolymer.

In a twenty-third aspect, a crosslinkable thermoplastic composition comprises the crosslinkable thermoplastic composition according to any one of the sixteenth through twenty-second aspects, wherein the silane-grafted propylene-based elastomer is formed from a propylene-based elastomer having a density of from 0.85 g/cm³ to 0.90 g/cm³.

In a twenty-fourth aspect, a crosslinkable thermoplastic composition comprises the crosslinkable thermoplastic composition according to any one of the sixteenth through twenty-third aspects, wherein the silane-grafted polyethylene homopolymer is formed from a polyethylene homopolymer having a weight average molecular weight of from 10,000 g/mol to 500,000 g/mol.

In a twenty-fifth aspect, a crosslinkable thermoplastic composition comprises the crosslinkable thermoplastic composition according to any one of the sixteenth through twenty-fourth aspects, wherein the silane-grafted polyethylene homopolymer is formed from a polyethylene homopolymer having a percent crystallinity of greater than 40%.

In a twenty-sixth aspect, a crosslinkable thermoplastic composition comprises the crosslinkable thermoplastic composition according to any one of the sixteenth through twenty-fifth aspects, wherein the silane-grafted polyethylene homopolymer is formed from a recycled polyethylene homopolymer.

In a twenty-seventh aspect, a crosslinkable thermoplastic composition comprises the crosslinkable thermoplastic composition according to any one of the sixteenth through twenty-sixth aspects, wherein the silane-grafted ethylene-based elastomer, the silane-grafted propylene-based elastomer, and the silane-grafted polyethylene homopolymer are prepared by reacting an ethylene-based elastomer, a propylene-based elastomer, and a polyethylene homopolymer with a vinyl silane and an organic peroxide.

In a twenty-eighth aspect, a crosslinkable thermoplastic composition comprises the crosslinkable thermoplastic composition according to the twenty-seventh aspect, wherein the organic peroxide is selected from the group consisting of di-t-butyl peroxide; t-butyl cumyl peroxide; dicumyl peroxide; 1,3-bis(t-butylperoxyisopropyl)benzene, n-butyl-4,4-bis(t-butyl-peroxy) valerate; benzoyl peroxide; 2,5-bis(t-butylperoxy)-2,5-dimethylhexyne-3; cumyl hydroperoxide; t-butyleperoxy isopropyl carbonate; t-butylperbenzoate; bis(2-methylbenzoyl) peroxide; bis(4-methylbenzoyl) peroxide; t-butyl peroctoate; methyl ethyl ketone peroxide; lauryl peroxide; tert-butyl peracetate; di-t-amyl peroxide; t-amyl peroxybenzoate; 1,1-bis(t-butylperoxy)-3,3,5-trimethylcyclohexane; 2,5-bis(t-butylperoxy)-2,5 dimethyl hexane; 2,4-dichlorobenzoyl peroxide; and combinations thereof.

In a twenty-ninth aspect, a crosslinkable thermoplastic composition comprises the crosslinkable thermoplastic composition according to any one of the sixteenth through twenty-sixth aspects, wherein the silane-grafted ethylene-based elastomer, the silane-grafted propylene-based elastomer, and the silane-grafted polyethylene homopolymer each include a silane moiety that includes at least one —OR group, where R is a monovalent hydrocarbon group that has from 1 to 12 carbon atoms.

According to a thirtieth aspect, a method of forming a crosslinkable silane-grafted polyolefin composition is provided. The method comprises reacting 10 wt. % to 80 wt. % of an ethylene-based elastomer; 10 wt. % to 80 wt. % of a propylene-based elastomer; 10 wt. % to 40 wt. % of a polyethylene homopolymer; 0.5 wt. % to 5 wt. % of a vinyl silane; and 0.05 wt. % to 1.5 wt. % of an organic peroxide.

In a thirty-first aspect, a method comprises the method according to the thirtieth aspect, wherein the ethylene-based elastomer is an ethylene-alpha olefin copolymer.

In a thirty-second aspect, a method comprises the method according to the thirtieth or thirty-first aspects, wherein the ethylene-based elastomer has a density of from 0.86 g/cm³ to 0.90 g/cm³.

In a thirty-third aspect, a method comprises the method according to any one of the thirtieth through thirty-second aspects, wherein the propylene-based elastomer is a propylene-alpha olefin copolymer.

In a thirty-fourth aspect, a method comprises the method according to any one of the thirtieth through thirty-third-aspects, wherein the propylene-based elastomer has a density of from 0.85 g/cm³ to 0.90 g/cm³.

In a thirty-fifth aspect, a method comprises the method according to any one of the thirtieth through thirty-fourth third aspects, wherein the polyethylene homopolymer has a weight average molecular weight of from 10,000 g/mol to 500,000 g/mol.

In a thirty-sixth aspect, a method comprises the method according to any one of the thirtieth through thirty-fifth aspects, wherein the polyethylene homopolymer has a percent crystallinity of greater than 40%.

In a thirty-seventh aspect, a method comprises the method according to any one of the thirtieth through thirty-sixth fifth aspects, wherein the polyethylene homopolymer is a recycled polyethylene homopolymer.

In a thirty-eighth aspect, a method comprises the method according to any one of the thirtieth through thirty-seventh aspects, wherein the organic peroxide is selected from the group consisting of di-t-butyl peroxide; t-butyl cumyl peroxide; dicumyl peroxide; 1,3-bis(t-butylperoxyisopropyl)benzene, n-butyl-4,4-bis(t-butyl-peroxy) valerate; benzoyl peroxide; 2,5-bis(t-butylperoxy)-2,5-dimethylhexyne-3; cumyl hydroperoxide; t-butyleperoxy isopropyl carbonate; t-butylperbenzoate; bis(2-methylbenzoyl) peroxide; bis(4-methylbenzoyl) peroxide; t-butyl peroctoate; methyl ethyl ketone peroxide; lauryl peroxide; tert-butyl peracetate; di-t-amyl peroxide; t-amyl peroxybenzoate; 1,1-bis(t-butylperoxy)-3,3,5-trimethylcyclohexane; 2,5-bis(t-butylperoxy)-2,5 dimethyl hexane; 2,4-dichlorobenzoyl peroxide; and combinations thereof.

In a thirty-ninth aspect, a method comprises the method according to any one of the thirtieth through thirty-eighth aspects, wherein the vinyl silane is selected from the group consisting of vinyl triethoxysilane, p-styryl trimethoxy silane, vinylbenzylethylenediaminopropyltrimethoxysilane, methylvinyldimethoxysilane, vinyldimethyl methoxysilane, divinyldimethoxysilane, vinyl trimethoxysilane, vinyltris (2-methoxyethoxy) silane, and combinations thereof.

In a fortieth aspect, a method comprises the method according to any one of the thirtieth through thirty-eighth aspects, further comprising forming a crosslinkable thermoplastic composition by blending the crosslinkable silane-grafted polyolefin composition with 0.5 wt. % to 8 wt. % of a moisture cure catalyst, based on a total weight of the crosslinkable thermoplastic composition.

In a forty-first aspect, a method comprises the method according to the fortieth aspect, wherein the moisture cure catalyst comprises an organic base, a carboxylic acid, a metallic stearate, an organometallic compound, or a combination thereof.

In a forty-second aspect, a method comprises the method according to any one of the fortieth through forty-first aspects, further comprising: extruding the crosslinkable thermoplastic composition; and curing the extruded crosslinkable thermoplastic composition to form a cured article.

In a forty-third aspect, a method comprises the method according to any one of the fortieth through forty-second first aspects, wherein curing the extruded crosslinkable thermoplastic composition comprises curing the extruded crosslinkable thermoplastic composition at a temperature of from 20° C. to 100° C.

In a forty-fourth aspect, a method comprises the method according to one of the fortieth or forty-third aspects, wherein the cured article has a Shore A hardness of from 60 to 90.

In a forty-fifth aspect, a method comprises the method according to any one of the fortieth through forty-fourth aspects, wherein the cured article has a compression set of from 5% to 50% at 150° C.

In a forty-sixthaspect, a method comprises the method according to any one of the fortieth through forty-fifth aspects, wherein the cured article comprises a sheet having a thickness of from 0.12 mm to 1 mm.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### DETAILED DESCRIPTION

Various technologies pertaining to crosslinkable elastomeric compositions and methods of making the same are now described with reference to various embodiments. The disclosure should not be construed as limited to the embodiments set forth herein. Rather, these embodiments are provided so that this disclosure will be thorough and complete, and will fully convey the subject matter to those skilled in the art.

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise. In addition, the articles “a” and “an” as used in this application and the appended claims should generally be construed to mean “one or more” unless specified otherwise or clear from the context to be directed to a singular form.

Moreover, the term “or” is intended to mean an inclusive “or” rather than an exclusive “or.” That is, unless specified otherwise, or clear from the context, the phrase “X comprises A or B” is intended to mean any of the natural inclusive permutations. That is, the phrase “X comprises A or B” is satisfied by any of the following instances: X comprises A; X comprises B; or X comprises both A and B.

Additionally, as used herein, the term “exemplary” is intended to mean serving as an illustration or example of something, and is not intended to indicate a preference.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

In general, various embodiments described herein provide a crosslinkable elastomeric material that includes a silane-grafted polyolefin composition. The silane-grafted polyolefin composition comprises a novel polymer blend of at least one silane-grafted ethylene-based elastomer, at least one silane-grafted propylene-based polymer, and at least one silane-grafted polyethylene homopolymer. The crosslinkable elastomeric composition forms a crosslinkable thermoplastic composition that can be processed according to thermoplastic processes rather than thermoset processes, but may be cured to form a thermoset product.

As used herein, the term “thermoplastic” refers to a polymer that softens when exposed to heat and returns to its original condition when at room temperature. In various embodiments, the crosslinkable thermoplastic composition includes properties of a thermoplastic material as well as properties of a thermoset material. As used herein, the term “thermoset” refers to a polymer that solidifies and irreversibly sets or crosslinks when cured. Accordingly, various embodiments described herein are thermoplastic materials that can be softened by heating so that the materials can flow until being set and crosslinked. The balance of thermoplastic and thermoset properties of the various embodiments can provide energy savings to manufacturers by enabling the articles to be crosslinked at ambient conditions instead of requiring significant amounts of energy to steam treat or heat treat the polymers to promote curing. In particular, the ability of various embodiments described herein to be crosslinked at ambient conditions can be attributed, at least in part, to the particular blend of polymers included in the crosslinkable elastomeric composition. Accordingly, various embodiments described herein provide for thermoset products that can be prepared using more energy-efficient processes than conventional thermoset products. Additionally, the use of polyethylene homopolymers can enable the use of recycled polyethylene content, thereby providing more environmentally-friendly and sustainable products.

### Silane-Grafted Polyolefin Composition

The crosslinkable elastomeric compositions described herein are based on a novel blend of silane-grafted polymers. As used herein, the term “polymer” includes homopolymers, copolymers, terpolymers, and mixtures thereof. The term “homopolymer” refers to a polymer which is made by linking olefin monomers, in the absence of comonomers (e.g., a single type of monomer is polymerized). The blend of silane-grafted polymers includes at least one ethylene-based elastomer, at least one propylene-based elastomer, and at least one polyethylene homopolymer. According to various embodiments, the polymers are modified from their original form by grafting a silane onto the backbone of the polymer.

In general, the silane-grafted polyolefin composition is prepared by reacting from 10 wt. % to 80 wt. % of at least one ethylene-based elastomer, from 10 wt. % to 80 wt. % of at least one propylene-based elastomer, and from 10 wt. % to 40 wt. % of at least one polyethylene homopolymer with a vinyl silane and an organic peroxide at an elevated temperature. In various embodiments, the reaction is effective to graft silane groups onto the backbone of the ethylene-based elastomer, the propylene-based elastomer, and the polyethylene homopolymer, thereby forming the novel blend of silane-grafted polymers.

In various embodiments, the ethylene-based elastomer includes ethylene and one or more additional polymerizable monomers other than ethylene. As described above, the ethylene-based elastomer can be included in the polymer blend in an amount of 10 wt. % to 80 wt. %, depending on the particular application. For example, the ethylene-based elastomer can be included in an amount of from 10 wt. % to 80 wt. %, from 10 wt. % to 70 wt. %, from 10 wt. % to 60 wt. %, from 10 wt. % to 50 wt. %, from 10 wt. % to 40 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 30 wt. % to 80 wt. %, from 30 wt. % to 70 wt. %, from 30 wt. % to 60 wt. %, from 30 wt. % to 50 wt. %, or from 30 wt. % to 40 wt. %, based on a total weight of the reaction mixture to form the silane-grafted polymers, including any and all ranges and subranges therein. The particular amount of ethylene-based polymer can vary depending on, for example, a target durometer of the final product or processing requirements for the polymeric blend.

In any of the exemplary embodiments, the ethylene-based elastomer can be an ethylene/α-olefin copolymer in the form of a block copolymer or a random copolymer. In some embodiments, the ethylene-based elastomer is an ethylene/α-olefin block copolymer.

As used herein, the term “comonomer” refers to the olefin comonomers which are suitable for being polymerized with olefin monomers, such as ethylene (in the case of the ethylene-based elastomer) or propylene monomers (in the case of the propylene-based elastomer). Comonomers can include, by way of example and not limitation, straight-chain or branched aliphatic C₃-C₂₀ α-olefins, such as propylene, 1-butene, 1-pentene, 3-methyl-1-butene, 4-methyl-1-pentene, 3-methyl-1 -pentene, 1-hexene, 1-octene, 1-decene, 1-dodecene, 1-tetradecene, 1-hexadecene, 1-octadecene, and 1-eicosene.

The ethylene-based elastomer of various embodiments has an ethylene content of greater than or equal to about 30 wt. %. For example, the ethylene-based elastomer can have an ethylene content of greater than or equal to about 30 wt. %, greater than or equal to about 35 wt. %, greater than or equal to about 40 wt. %, greater than or equal to about 45 wt. %, greater than or equal to about 50 wt. %, greater than or equal to about 55 wt. %, greater than or equal to about 60 wt. %, greater than or equal to about 65 wt. %, greater than or equal to about 70 wt. %, greater than or equal to about 75 wt. %, greater than or equal to about 80 wt. %, or even greater than or equal to about 85 wt. %, based on a total weight of the ethylene-based elastomer.

In various embodiments, ethylene comprises the majority mole fraction of the ethylene-based elastomer (i.e., ethylene comprises at least 50 mol. % of the ethylene-based elastomer). In some embodiments, the ethylene-based elastomer includes at least 60 mol. %, at least 70 mol. %, or at least 80 mol. % ethylene. For example, the ethylene-based elastomer can include from 50 mol. % to 90 mol. % ethylene, from 60 mol. % to 85 mol. % ethylene, or from 65 mol % to 80 mol. % ethylene, including any and all ranges and subranges therein. In particular embodiments, the ethylene-based elastomer can include an ethylene content of greater than 80 mol %, and an α-olefin content of from 10 mol. % to 20 mol %, or from 15 mol. % to 20 mol. %, including any and all ranges and subranges therein.

The ethylene-based elastomer, in various embodiments, has a density of 0.86 g/cm³ to 0.90 g/cm³. For example, the ethylene-based elastomer can have a density of from 0.86 g/cm³ to 0.90 g/cm³, from 0.86 g/cm³ to 0.89 g/cm³, from 0.86 to 0.88 g/cm³, or from 0.86 g/cm³ to 0.87 g/cm³, including any and all ranges and subranges therein, when measured in accordance with ASTM D792. In various embodiments, the ethylene-based elastomer has a Shore A hardness of 40 to 70, such as from 40 to 65, from 40 to 60, from 45 to 70, from 45 to 65, from 45 to 60, from 50 to 70, from 50 to 65, or from 50 to 60, including any and all ranges and subranges therein, as measured in accordance with ASTM D2240.

According to various embodiments, the ethylene-based elastomer has a melt index (MI) of from 0.1 g/10 min to 30 g/10 min, from 0.1 g/10 min to 20 g/10 min, from 0.1 g/10 min to 15 g/10 min, from 1 g/10 min to 30 g/10 min, from 1 g/10 min to 20 g/10 min, from 1 g/10 min to 15 g/10 min, from 5 g/10 min to 30 g/10 min, from 5 g/10 min to 20 g/10 min, or from 5 g/10 min to 15 g/10 min, including any and all ranges and subranges therein, as measured in accordance with ASTM D1238 (190° C.; 2.16 kg).

Suitable ethylene-based elastomers for use in various embodiments include those elastomers commercially available under the tradenames INFUSE, AFFINITY, and ENGAGE (all from The Dow Chemical Company (Midland, MI)), TAFMER (available from Mitsui Chemicals (Tokyo, Japan)) and EXACT (available from Exxon Chemical Company (Houston, TX)).

The polymer blend of various embodiments further includes at least one propylene-based elastomer. In various embodiments, the propylene-based elastomer includes propylene and one or more additional polymerizable monomers other than propylene. As described above, the propylene-based elastomer can be included in the polymer blend in an amount of 10 wt. % to 80 wt. %, depending on the particular application. For example, the propylene-based polymer can be included in an amount of from 10 wt. % to 80 wt. %, from 10 wt. % to 70 wt. %, from 10 wt. % to 60 wt. %, from 10 wt. % to 50 wt. %, from 10 wt. % to 40 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 30 wt. % to 80 wt. %, from 30 wt. % to 70 wt. %, from 30 wt. % to 60 wt. %, from 30 wt. % to 50 wt. %, or from 30 wt. % to 40 wt. %, based on a total weight of the reaction mixture to form the silane-grafted polymers, including any and all ranges and subranges therein.

In any of the exemplary embodiments, the propylene-based elastomer can be a propylene/α-olefin copolymer in the form of a block copolymer or a random copolymer. In some embodiments, the propylene-based elastomer is a propylene/α-olefin block copolymer. Without being bound by theory, it is believed that the α-olefin contained in the propylene/α-olefin copolymer can enable the propylene-based elastomer to form a grafted polymer with the silane crosslinker and crosslink during curing of the final product (thereby impacting the compression set of the final product), while the propylene can provide improved processability as compared to blends containing only ethylene-based polymers. Moreover, because of the propylene, the propylene-based elastomer may crosslink at lower levels as compared to ethylene-based polymers, thereby enabling the crosslinking of the final product to be carefully controlled.

Comonomers suitable for use in the propylene-based elastomer can include, by way of example and not limitation, straight-chain or branched aliphatic C₂ or C₄-C₂₀ α-olefins, such as ethylene, 1-butene, 1-pentene, 3-methyl-1-butene, 4-methyl-1-pentene, 3-methyl-1-pentene, 1-hexene, 1-octene, 1-decene, 1-dodecene, 1-tetradecene, 1-hexadecene, 1-octadecene, and 1-eicosene. In some particular embodiments, the propylene-based elastomer is a copolymer of propylene and ethylene.

In various embodiments, propylene comprises the majority mole fraction of the propylene-based elastomer (i.e., propylene comprises at least 50 mol. % of the propylene-based elastomer). In some embodiments, the propylene-based elastomer includes at least 60 mol. %, at least 70 mol. %, or at least 80 mol. % propylene. For example, the propylene-based elastomer can include from 50 mol. % to 92 mol. % propylene, from 60 mol. % to 91 mol. % propylene, or from 65 mol % to 88 mol. % propylene, including any and all ranges and subranges therein. In particular embodiments, the propylene-based elastomer can include a propylene content of greater than 80 mol %, and an α-olefin content of from 10 mol. % to 20 mol %, or from 15 mol. % to 20 mol. %, including any and all ranges and subranges therein. In some embodiments in which the propylene-based elastomer is a propylene/ethylene copolymer, the propylene-based elastomer can include from 8 mol. % to 32 mol. % ethylene, from 9 mol. % to 25 mol. % ethylene, from 12 mol. % to 22 mol. % ethylene, or from 13 mol. % to 20 mol. % ethylene, including any and all ranges and subranges therein.

The propylene-based elastomer, in various embodiments, has a density of 0.82 g/cm³ to 0.90 g/cm³. For example, the propylene-based elastomer can have a density of from 0.82 g/cm³ to 0.90 g/cm³, from 0.82 g/cm³ to 0.89 g/cm³, from 0.82 to 0.88 g/cm³, from 0.82 g/cm³ to 0.87 g/cm³, from 0.83 g/cm³ to 0.90 g/cm³, from 0.83 g/cm³ to 0.89 g/cm³, from 0.83 to 0.88 g/cm³, from 0.83 g/cm³ to 0.87 g/cm³, from 0.84 g/cm³ to 0.90 g/cm³, from 0.84 g/cm³ to 0.89 g/cm³, from 0.84 to 0.88 g/cm³, from 0.84 g/cm³ to 0.87 g/cm³, from 0.85 g/cm³ to 0.90 g/cm³, from 0.85 g/cm³ to 0.89 g/cm³, from 0.85 to 0.88 g/cm³, or from 0.85 g/cm³ to 0.87 g/cm³, including any and all ranges and subranges therein, when measured in accordance with ASTM D792. In various embodiments, the propylene-based elastomer has a Shore A hardness of 45 to 75, such as from 45 to 72, from 45 to 70, from 50 to 75, from 50 to 72, from 50 to 70, from 55 to 75, from 55 to 72, from 55 to 70, from 60 to 75, from 60 to 72, from 60 to 70, from 65 to 75, from 65 to 72, or from 65 to 70, including any and all ranges and subranges therein, as measured in accordance with ASTM D2240.

According to various embodiments, the propylene-based elastomer has a melt index (MI) of from 0.5 g/10 min to 21 g/10 min, from 0.5 g/10 min to 15 g/10 min, from 0.5 g/10 min to 10 g/10 min, from 0.5 g/10 min to 7.5 g/10 min, from 0.5 g/10 min to 5 g/10 min, from 0.5 g/10 min to 2 g/10 min, from 1 g/10 min to 21 g/10 min, from 1 g/10 min to 15 g/10 min, from 1 g/10 min to 10 g/10 min, from 1 g/10 min to 7.5 g/10 min, from 1 g/10 min to 5 g/10 min, or from 1 g/10 min to 2 g/10 min, including any and all ranges and subranges therein, as measured in accordance with ASTM D1238 (190° C.; 2.16 kg).

Suitable propylene-based elastomers for use in various embodiments include those elastomers commercially available under the tradenames VISTAMAXX™ (available from Exxon Chemical Company (Houston, TX)) and TAFMER™ XM (Mitsui Chemicals (Tokyo, Japan)).

In addition to the ethylene-based elastomer and the propylene-based elastomers described above, various embodiments of the silane-grafted polyolefin blend further include a polyethylene homopolymer in the polymer blend. As described above, the polyethylene homopolymer can be included in the polymer blend in an amount of 10 wt. % to 40 wt. %, depending on the particular application. For example, the polyethylene homopolymer can be included in an amount of from 10 wt. % to 40 wt. %, from 10 wt. % to 35 wt. %, from 10 wt. % to 30 wt. %, from 15 wt. % to 40 wt. %, from 15 wt. % to 35 wt. %, from 15 wt. % to 30 wt. %, from 20 wt. % to 40 wt. %, from 20 wt. % to 35 wt. %, or from 20 wt. % to 30 wt. %, based on a total weight of the reaction mixture to form the silane-grafted polymers, including any and all ranges and subranges therein.

The polyethylene homopolymer can be an ultra-low density polyethylene (ULDPE), a low density polyethylene (LDPE), a linear low density polyethylene (LLDPE), or a high density polyethylene (HDPE). Without being bound by theory, it is believed that the incorporation of the polyethylene homopolymer can improve various processing characteristics of the polymer blend, including setting characteristics of the silane-grafted polyolefin composition. For example, the use of a polyethylene homopolymer in the blend can reduce set time as compared to a blend including elastomers alone. Additionally, as will be discussed in greater detail below, the use of a vinyl silane and organic peroxide can be effective to graft silane groups onto the polyethylene homopolymer backbone, thereby enabling the polyethylene homopolymer to participate in crosslinking of the final product, thereby impacting the compression set of the final product.

According to various embodiments, the polyethylene homopolymer has a melt index (MI) of from 0.1 g/10 min to 5 g/10 min, from 0.1 g/10 min to 2.5 g/10 min, from 0.1 g/10 min to 1 g/10 min, from 0.2 g/10 min to 5 g/10 min, from 0.2 g/10 min to 2.5 g/10 min, from 0.2 g/10 min to 1 g/10 min, from 0.5 g/10 min to 5 g/10 min, from 0.5 g/10 min to 2.5 g/10 min, or from 0.5 g/10 min to 1 g/10 min, including any and all ranges and subranges therein, as measured in accordance with ASTM D1238 (190° C.; 2.16 kg).

The polyethylene homopolymer, in various embodiments, has a density of 0.90 g/cm³ to 1.00 g/cm³. For example, the polyethylene homopolymer can have a density of from 0.90 g/cm³ to 1.00 g/cm³, from 0.90 g/cm³ to 0.99 g/cm³, from 0.90 g/cm³ to 0.98 g/cm³, from 0.90 g/cm³ to 0.97 g/cm³, from 0.91 g/cm³ to 1.00 g/cm³, from 0.91 g/cm³ to 0.99 g/cm³, from 0.91 g/cm³ to 0.98 g/cm³, from 0.91 to 0.97 g/cm³, from 0.92 g/cm³ to 1.00 g/cm³, from 0.92 g/cm³ to 0.99 g/cm³, from 0.92 g/cm³ to 0.98 g/cm³, from 0.92 to 0.97 g/cm³, from 0.93 g/cm³ to 1.00 g/cm³, from 0.93 g/cm³ to 0.99 g/cm³, from 0.93 g/cm³ to 0.98 g/cm³, from 0.93 to 0.97 g/cm³, from 0.94 g/cm³ to 1.00 g/cm³, from 0.94 g/cm³ to 0.99 g/cm³, from 0.94 g/cm³ to 0.98 g/cm³, from 0.94 to 0.97 g/cm³, from 0.95 g/cm³ to 1.00 g/cm³, from 0.95 g/cm³ to 0.99 g/cm³, from 0.95 g/cm³ to 0.98 g/cm³, or from 0.95 to 0.97 g/cm³, including any and all ranges and subranges therein, when measured in accordance with ASTM D792.

According to some embodiments, the polyethylene homopolymer has a weight average molecular weight of from 10,000 g/mol to 500,000 g/mol, including from 10,000 g/mol to 400,000 g/mol, from 10,000 g/mol to 300,000 g/mol, from 10,000 g/mol to 250,000 g/mol, from 10,000 g/mol to 200,000 g/mol, from 25,000 g/mol to 500,000 g/mol, including from 25,000 g/mol to 400,000 g/mol, from 25,000 g/mol to 300,000 g/mol, from 25,000 g/mol to 250,000 g/mol, from 25,000 g/mol to 200,000 g/mol, from 50,000 g/mol to 500,000 g/mol, including from 50,000 g/mol to 400,000 g/mol, from 50,000 g/mol to 300,000 g/mol, from 50,000 g/mol to 250,000 g/mol, from 50,000 g/mol to 200,000 g/mol, from 80,000 g/mol to 500,000 g/mol, including from 80,000 g/mol to 400,000 g/mol, from 80,000 g/mol to 300,000 g/mol, from 80,000 g/mol to 250,000 g/mol, from 80,000 g/mol to 200,000 g/mol, from 100,000 g/mol to 500,000 g/mol, including from 100,000 g/mol to 400,000 g/mol, from 100,000 g/mol to 300,000 g/mol, from 100,000 g/mol to 250,000 g/mol, or from 100,000 g/mol to 200,000 g/mol, including any and all ranges and subranges therein.

In various embodiments, the polyethylene homopolymer has a percent crystallinity of greater than 40% when measured using differential scanning calorimetry (DSC). For example, the polyethylene homopolymer can have a crystallinity of greater than 40%, greater than 50%, or even greater than 60%. In embodiments, the polyethylene homopolymer has a percent crystallinity of from 40% to 90%, from 45% to 90%, from 50% to 90%, from 55% to 90%, from 60% to 90%, from 40% to 80%, from 45% to 80%, from 50% to 80%, from 55% to 80%, from 60% to 80%, from 40% to 70%, from 45% to 70%, from 50% to 70%, from 55% to 70%, or from 60% to 70%, when measured by DSC.

In various embodiments, the polyethylene homopolymer may include a recycled polyethylene homopolymer. As used herein, “recycled” refers to a resin that has been mechanically or chemically recycled or otherwise repurposed, including post-consumer and post-industrial resins. In some embodiments, the polyethylene homopolymer is a blend of recycled polyethylene homopolymer and virgin polyethylene homopolymer, or the polyethylene homopolymer can be entirely recycled polyethylene homopolymer. In embodiments in which the polyethylene homopolymer is a blend including recycled and virgin content, the amount of the recycled resin can be included in an amount of from 50 wt. % to 99 wt. %, from 50 wt. % to 95 wt. %, from 50 wt. % to 90 wt. %, from 50 wt. % to 80 wt. %, from 60 wt. % to 99 wt. %, from 60 wt. % to 95 wt. %, from 60 wt. % to 90 wt. %, from 60 wt. % to 80 wt. %, from 70 wt. % to 99 wt. %, from 70 wt. % to 95 wt. %, from 70 wt. % to 90 wt. %, from 70 wt. % to 80 wt. %, from 80 wt. % to 99 wt. %, from 80 wt. % to 95 wt. %, or from 80 wt. % to 90 wt. %, based on the total amount of polyethylene homopolymer, including any and all ranges and subranges therein. The use of recycled polyethylene can provide sustainability, lower the cost of materials, and provide a more environmentally-friendly product.

According to various embodiments, the silane-grafted polyolefin composition is the reaction product of the polymer blend (e.g., the ethylene-based elastomer, the propylene-based elastomer, and the polyethylene homopolymer), a free-radical generator, and a silane crosslinker (e.g., vinyl silane) at an elevated temperature. The reaction of the polymers with the free-radical generator and silane crosslinker is effective to graft silane groups onto the backbone of the polymers in the polymer blend, thereby creating the crosslinkable elastomeric composition.

In various embodiments, the free-radical generator generates free-radicals upon heating and can be selected from any of the known azo or diazo compounds, such as 2,2′-azobisisobutyronitrile and phenyl-azo-triphenylmethane. In embodiments, the free-radical generator is selected from organic peroxides such as hydroperoxides, diacyl peroxides, ketone peroxides, peroxyesters, dialkyl peroxides, diaryl peroxides, aryl-alkyl peroxides peroxydicarbonates, peroxyketals, peroxy acids, acyl alkylsulfonyl peroxides and alkyl monoperoxydicarbonates.

Specific examples of suitable organic peroxides which may be used in embodiments of the disclosure include, but are not limited to, di-t-butyl peroxide; t-butyl cumyl peroxide; dicumyl peroxide; 1,3-bis(t-butylperoxyisopropyl)benzene, n-butyl-4,4-bis(t-butyl-peroxy) valerate; benzoyl peroxide; 2,5-bis(t-butylperoxy)-2,5-dimethylhexyne-3; cumyl hydroperoxide; t-butyleperoxy isopropyl carbonate; t-butylperbenzoate; bis(2-methylbenzoyl) peroxide; bis(4-methylbenzoyl) peroxide; t-butyl peroctoate; methyl ethyl ketone peroxide; lauryl peroxide; tert-butyl peracetate; di-t-amyl peroxide; t-amyl peroxybenzoate; 1,1-bis(t-butylperoxy)-3,3,5-trimethylcyclohexane; 2,5-bis(t-butylperoxy)-2,5 dimethyl hexane; 2,4-dichlorobenzoyl peroxide; and combinations thereof. In particular embodiments, the peroxide is selected from dicumyl peroxide and di-t-butyl peroxide.

The organic peroxide is included in the reaction mixture in an amount of from 0.05 wt. % to 1.5 wt. %, based on the total weight of the grafting reaction mixture. For example, the reaction mixture can include from 0.05 wt. % to 1.5 wt. %, from 0.05 wt. % to 1.0 wt. %, from 0.05 wt. % to 0.75 wt. %, from 0.05 wt. % to 0.50 wt. %, from 0.05 wt. % to 0.25 wt. %, 0.07 wt. % to 1.5 wt. %, from 0.07 wt. % to 1.0 wt. %, from 0.07 wt. % to 0.75 wt. %, from 0.07 wt. % to 0.50 wt. %, from 0.07 wt. % to 0.25 wt. %, 0.10 wt. % to 1.5 wt. %, from 0.10 wt. % to 1.0 wt. %, from 0.10 wt. % to 0.75 wt. %, from 0.10 wt. % to 0.50 wt. %, or from 0.10 wt. % to 0.25 wt. % organic peroxide, including any and all ranges and subranges therein.

In embodiments, the organic peroxide has a density greater than or equal to 1.00 g/cm³ or even greater than or equal to 1.05 g/cm³. In embodiments, the organic peroxide can have a density less than or equal to 1.20 g/cm³ or even less than or equal to 1.15 g/cm³. In embodiments, the organic peroxide can have a density from 1.00 g/cm³ to 1.20 g/cm³, from 1.00 g/cm³ to 1.15 g/cm³, from 1.05 g/cm³ to 1.20 g/cm³, or even from 1.05 g/cm³ to 1.15 g/cm³, including any and all ranges and subranges therein.

In embodiments, the organic peroxide has a melting point greater than or equal to 75° C. or even greater than or equal to 100° C. In embodiments, the organic peroxide has a melting point less than or equal to 150° C. or even less than or equal to 125° C. In embodiments, the organic peroxide has a melting point from 75° C. to 150° C., from 75° C. to 125° C., from 100° C. to 150° C., or even from 100° C. to 125° C., including any and all ranges and subranges therein.

Suitable commercial embodiments of the organic peroxide are available under the PERKADOX brand, such as BC-FF, from AkzoNobel.

In the presence of a silane crosslinker, the reaction can be effective to graft the moiety onto the backbone of the polymer. In various embodiments, the silane crosslinker includes free-radically reactive silanes. In embodiments, the silane crosslinker can be vinyl trialkoxysilane. For example, in embodiments, the silane crosslinker can be vinyl triethoxysilane, p-styryl trimethoxy silane, vinylbenzylethylenediaminopropyltrimethoxysilane, methylvinyldimethoxysilane, vinyldimethyl methoxysilane, divinyldimethoxysilane, vinyl trimethoxysilane, vinyltris (2-methoxyethoxy) silane, or a combination thereof. In various embodiments, the silane crosslinker includes at least onevinyl group and at least one —OR group, where each R is individually a monovalent hydrocarbon group that has from 1 to 12 carbon atoms. In embodiments, the —OR group is a hydrocarbyloxy group, an alkoxy group, or the like. In various embodiments, the silane crosslinker includes one vinyl group and three —OR group. Other silane crosslinkers including a first functional group and a second functional group can be included in various embodiments, provided the silane crosslinker includes at least one functional group capable of crosslinking the silane-grafted polymer in the presence of a moisture cure crosslinking catalyst.

Commercially available silane crosslinkers that are suitable for use in various aspects include, by way of example and not limitation, those available under the trade names SILQUEST A-171 (Momentive Performance Materials Inc., New York). However, it should be appreciated that any silane or mixtures of silanes known in the art that can effectively graft to and crosslink an olefin polymer can be used in various embodiments.

In embodiments, the silane crosslinker has a specific gravity greater than or equal to 0.9 g/cm³ or even greater than or equal to 0.95 g/cm³. In embodiments, the silane crosslinker has a specific gravity less than or equal to 1.05 g/cm³ or even less than or equal to 1 g/cm³. In embodiments, the silane crosslinker has a specific gravity from 0.9 g/cm³ to 1.05 g/cm³, from 0.9 g/cm³ to 1 g/cm³, from 0.95 g/cm³ to 1.05 g/cm³, or even from 0.95 g/cm³ to 1 g/cm³, including any and all ranges and subranges therein.

In embodiments, the silane crosslinker has a melting point greater than or equal to 75° C. or even greater than or equal to 100° C. In embodiments, the silane crosslinker can have a melting point less than or equal to 150° C. or even less than or equal to 125° C. In embodiments, the silane crosslinker has a melting point from 75° C. to 150° C., from 75° C. to 125° C., from 100° C. to 150° C., or even from 100° C. to 125° C., including any and all ranges and subranges therein.

The silane crosslinker is included in the reaction mixture in an amount of from 0.5 wt. % to 5 wt. %, based on the total weight of the grafting reaction mixture. For example, the reaction mixture can include from 0.5 wt. % to 5 wt. %, from 0.5 wt. % to 4 wt. %, from 0.5 wt. % to 3 wt. %, from 0.5 wt. % to 2 wt. %, 0.75 wt. % to 5 wt. %, from 0.75 wt. % to 4 wt. %, from 0.75 wt. % to 3 wt. %, from 0.75 wt. % to 2 wt. %, 1 wt. % to 5 wt. %, from 1 wt. % to 4 wt. %, from 1 wt. % to 3 wt. %, or from 1 wt. % to 2 wt. % silane crosslinker, including any and all ranges and subranges therein. It should be appreciated that the amount of silane crosslinker can vary based on the polymers included in the polymer blend, the particular silane, the processing conditions, the target grafting level, and other factors.

In various embodiments, the polymer blend (e.g., the ethylene-based elastomer, the propylene-based elastomer, and the polyethylene homopolymer) and the free-radical generator (e.g., the organic peroxide) are reacted at elevated temperatures. The reaction can be carried out in any equipment conventionally used for mixing or blending components while heating, such as an internal mixer or a twin-screw extruder. The temperature during the reaction is, according to various embodiments, from about 50° C. to about 300° C., from about 50° C. to about 250° C., from about 75° C. to about 300° C., from about 75° C. to about 250° C., from about 100° C. to about 300° C., or from about 100° C. to about 250° C., including any and all ranges and subranges therein. In embodiments, the mixing of the polymer blend and the free-radical generator is carried out at the elevated temperatures to activate the free-radical generator, although it is contemplated that the polymers and free-radical generator can be blended first at a temperature that is below the decomposition temperature of the free-radical generator and subsequently heated to initiate the reaction.

The grafting reaction can be accomplished in batch or continuous fashion. In embodiments, the ethylene-based elastomer, the propylene-based elastomer, the polyethylene homopolymer, the free-radical generator, and the silane crosslinker are introduced to an extruder where they are heated, combined, and reacted before being extruded through a die to form a molten crosslinkable elastomeric composition. In some embodiments, the polymers and the free-radical generator are mixed in a first stage of the extruder, and the silane crosslinker is added to a second stage of the extruder. The molten crosslinkable elastomeric composition is cooled and then may be used as-is, re-shaped, and/or pelletized to form a crosslinkable polymer material, such as a plurality of pellets. Alternatively, all of the ingredients can be added to a feeder together for mixing.

In embodiments, the silane grafted polymers, include a silane graft or a silane moiety that includes at least one —OR group, where R is a monovalent hydrocarbon group that has from 1 to 12 carbon atoms. In embodiments, the —OR group is a hydrocarbyloxy group, an alkoxy group, or the like.

Thus, in any of the exemplary embodiments, the crosslinkable polymer material may be provided in any form needed or desirable for a particular application, such as, for example, as one or more pellets, blocks, sheets, films, ribbons, and the like.

In various embodiments, the crosslinkable polymer material has a Shore A hardness of from 40 to 100, from 40 to 95, from 40 to 90, from 40 to 85, from 40 to 80, from 40 to 75, from 40 to 70, from 50 to 100, from 50 to 95, from 50 to 90, from 50 to 85, from 50 to 80, from 50 to 75, from 50 to 70, from 60 to 100, from 60 to 95, from 60 to 90, from 60 to 85, from 60 to 80, from 60 to 75, or from 60 to 70, including any and all ranges and subranges therein, when measured in accordance with ASTM D2240. In embodiments, the hardness of the crosslinkable polymer material is from 50 Shore A to 50 Shore D, or from 60 Shore A to 90 Shore A.

In various embodiments, the crosslinkable polymer material has a tensile stress at 100% elongation (100% modulus) of from 100 psi to 1800 psi when measured in accordance with ASTM D412, die C. For example, the crosslinkable polymer material can have a tensile stress of from 100 psi to 1800 psi, from 100 psi to 1600 psi, from 100 psi to 1400 psi, from 100 psi to 1200 psi, from 100 psi to 1000 psi, from 100 psi to 800 psi, from 100 psi to 600 psi, from 200 psi to 1800 psi, from 200 psi to 1600 psi, from 200 psi to 1400 psi, from 200 psi to 1200 psi, from 200 psi to 1000 psi, from 200 psi to 800 psi, from 200 psi to 600 psi, from 400 psi to 1800 psi, from 400 psi to 1600 psi, from 400 psi to 1400 psi, from 400 psi to 1200 psi, from 400 psi to 1000 psi, from 400 psi to 800 psi, or from 400 psi to 600 psi, including any and all ranges and subranges therein.

The crosslinkable polymer material of various embodiments further has a tensile strength at break of 200 psi to 2000 psi when measured in accordance with ASTM D412, die C of from 200 psi to 2000 psi. For example, the crosslinkable polymer material can have a tensile strength of from 200 psi to 2000 psi, from 200 psi to 1800 psi, from 200 psi to 1600 psi, from 200 psi to 1500 psi, from 200 psi to 1250 psi, from 200 psi to 1000 psi, from 400 psi to 2000 psi, from 400 psi to 1800 psi, from 400 psi to 1600 psi, from 400 psi to 1500 psi, from 400 psi to 1250 psi, from 400 psi to 1000 psi, from 600 psi to 2000 psi, from 600 psi to 1800 psi, from 600 psi to 1600 psi, from 600 psi to 1500 psi, from 600 psi to 1250 psi, or from 600 psi to 1000 psi, including any and all ranges and subranges therein.

In various embodiments, the crosslinkable polymer material has a tensile elongation at break of from 50% to 1,000% when measured in accordance with ASTM D412, die C. For example, the crosslinkable polymer material can have a tensile elongation at break of from 50% to 1,000%, from 50% to 900%, from 50% to 800%, from 50% to 700%, from 50% to 600%, from 100% to 1,000%, from 100% to 900%, from 100% to 800%, from 100% to 700%, from 100% to 600%, from 200% to 1,000%, from 200% to 900%, from 200% to 800%, from 200% to 700%, from 200% to 600%, from 300% to 1,000%, from 300% to 900%, from 300% to 800%, from 300% to 700%, from 300% to 600%, from 400% to 1,000%, from 400% to 900%, from 400% to 800%, from 400% to 700%, from 400% to 600%, from 500% to 1,000%, from 500% to 900%, from 500% to 800%, from 500% to 700%, or from 500% to 600%, including any and all ranges and subranges therein.

The crosslinkable polymer material includes from 10 wt. % to 80 wt. % of silane-grafted ethylene-based elastomer, from 10 wt. % to 80 wt. % of silane-grafted propylene-based elastomer, and from 10 wt. % to 40 wt. % of silane grafted polyethylene homopolymer, based on a total weight of the crosslinkable polymer material. For example, the crosslinkable polymer material can include silane-grafted ethylene-based polymer in an amount of from 10 wt. % to 80 wt. %, from 10 wt. % to 70 wt. %, from 10 wt. % to 60 wt. %, from 10 wt. % to 50 wt. %, from 10 wt. % to 40 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 30 wt. % to 80 wt. %, from 30 wt. % to 70 wt. %, from 30 wt. % to 60 wt. %, from 30 wt. % to 50 wt. %, or from 30 wt. % to 40 wt. %, based on a total weight of the crosslinkable polymer material, including any and all ranges and subranges therein. The crosslinkable polymer material can also include silane-grafted propylene-based polymer in an amount of from 10 wt. % to 80 wt. %, from 10 wt. % to 70 wt. %, from 10 wt. % to 60 wt. %, from 10 wt. % to 50 wt. %, from 10 wt. % to 40 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 30 wt. % to 80 wt. %, from 30 wt. % to 70 wt. %, from 30 wt. % to 60 wt. %, from 30 wt. % to 50 wt. %, or from 30 wt. % to 40 wt. %, based on a total weight of the crosslinkable polymer material, including any and all ranges and subranges therein. The crosslinkable polymer material can further include silane-grafted polyethylene homopolymer in an amount of from 10 wt. % to 40 wt. %, from 10 wt. % to 35 wt. %, from 10 wt. % to 30 wt. %, from 15 wt. % to 40 wt. %, from 15 wt. % to 35 wt. %, from 15 wt. % to 30 wt. %, from 20 wt. % to 40 wt. %, from 20 wt. % to 35 wt. %, or from 20 wt. % to 30 wt. %, based on a total weight of the crosslinkable polymer material, including any and all ranges and subranges therein.

### Crosslinkable Thermoplastic Compositions

In various embodiments, the crosslinkable elastomeric composition (e.g., the crosslinkable polymer material (i.e., pellets) is combined with a crosslinking catalyst to form a crosslinkable thermoplastic composition. The crosslinking catalyst in embodiments can facilitate the hydrolysis and condensation of the silane grafts on the silane-grafted polymers to form crosslinks. In some embodiments, the crosslinking catalyst can include an organic base, a carboxylic acid, a metallic stearate, an organometallic compound (e.g., organic titanates and complexes or carboxylates of lead, cobalt, iron, nickel, zinc, and tin), or a combination thereof. Other crosslinking catalysts can be used, depending on the particular embodiment.

The crosslinking catalyst of various embodiments is a moisture cure catalyst, which promotes curing of the silane-grafted polymers with moisture (e.g., water vapor). The moisture cure catalyst can be present in an amount of 0 wt. % to 8 wt. %, based on a total weight of the crosslinkable thermoplastic composition. For example, the moisture cure catalyst can be present in an amount of from 0.5 wt. % to 8 wt. %, from 0.5 wt. % to 7 wt. %, from 0.5 wt. % to 6 wt. %, from 0.5 wt. % to 5 wt. %, from 1 wt. % to 8 wt. %, from 1 wt. % to 7 wt. %, from 1 wt. % to 6 wt. %, from 1 wt. % to 5 wt. %, from 2 wt. % to 8 wt. %, from 2 wt. % to 7 wt. %, from 2 wt. % to 6 wt. %, or from 2 wt. % to 5 wt. %, based on a total weight of the crosslinkable thermoplastic composition, including any and all ranges and subranges therein.

In various embodiments, the crosslinkable elastomeric composition and the crosslinking catalyst are mixed together (e.g., using a single screw or twin screw extruder) to form the crosslinkable thermoplastic composition. In some embodiments, one or more optional additives may be added with the crosslinkable elastomeric composition and the crosslinking catalyst to adjust the final material properties of the final article. As a result of the combination of the crosslinkable elastomeric composition with the crosslinking catalyst, reactive silanol groups are formed on the silane grafts that can subsequently crosslink when exposed to humidity and/or heat. The crosslinking reaction can be carried out in, for example, a reactive single screw extruder or using other suitable equipment.

The crosslinkable thermoplastic composition can be extruded or molded into the desired, uncured, thermoplastic article. Although referred to as an “uncured” article, it should be appreciated that some amount of crosslinking can occur during the extrusion of the crosslinkable polymer pellets and the crosslinking catalyst. However, it is expected that the uncured article is less than about 70% cured where the gel test of ASTM D2765 is used to determine the amount of crosslinking in the final, cured article.

In various embodiments, the uncured thermoplastic article is cured at ambient or elevated temperature and/or humidity to form the cured thermoplastic article. Put another way, in embodiments, the crosslinkable thermoplastic composition can be cured at a temperature of from 20° C. to 100° C. In the curing process, the water (e.g., water vapor in the ambient air) hydrolyzes the silane of the silane-grafted polymers to produce a silanol. The silanol groups can be condensed to form Si—O—Si crosslink sites. The number of crosslink sites can be regulated through one or more variables in the production process, including, for example, the amount of catalyst used, the grafting level, and levels of polyolefins present in the polymer blend.

Crosslinking can occur over a period of time that is on the order of seconds or hours. In embodiments, curing can take from 20 seconds to 200 seconds, from 1 hour to 20 hours, from 10 hours to 20 hours, from 15 hours to 20 hours, from 5 hours to 15 hours, from 1 hour to 8 hours, or from 3 hours to 6 hours, including any and all ranges and subranges therein.

In various embodiments, the crosslinkable elastomeric composition may be cured in the absence of a crosslinking catalyst to form a crosslinkable thermoplastic composition. In these or other embodiments, crosslinking may be achieved through heat and humidity.

### Cured Articles

According to some embodiments, the cured article is a thermoset article, having excellent compression set properties at elevated temperatures. It can also be soft and flexible, based on the hardness of the material. Moreover, as described hereinabove, the cured article is a sustainable product as a result of the recycled polyethylene content.

In general, the crosslinked thermoplastic article has a Shore A hardness of from 40 to 100, from 40 to 95, from 40 to 90, from 40 to 85, from 40 to 80, from 50 to 100, from 50 to 95, from 50 to 90, from 50 to 85, from 50 to 80, from 60 to 100, from 60 to 95, from 60 to 90, from 60 to 85, from 60 to 80, from 70 to 100, from 70 to 95, from 70 to 90, from 70 to 85, or from 70 to 80, including any and all ranges and subranges therein, when measured in accordance with ASTM D2240 (10 s delay). In embodiments, the hardness of the crosslinked thermoplastic article is from 50 Shore A to 50 Shore D, or from 60 Shore A to 90 Shore A.

In various embodiments, the crosslinked thermoplastic article has a compression set of 5% to 50% at 150° C. for 22 hours, when measured in accordance with ASTM D395B (25% deflection). For example, the crosslinked thermoplastic article can have a compression set of from 5% to 50%, from 10% to 50%, from 15% to 50%, from 5% to 45%, from 10% to 45%, from 15% to 45%, from 5% to 40%, from 10% to 40%, from 15% to 40%, from 5% to 35%, from 10% to 35%, from 15% to 35%, from 5% to 30%, from 10% to 30%, from 15% to 30%, from 5% to 25%, from 10% to 25%, or from 15% to 25%, including any and all ranges and subranges therein, at 150° C. and 22 hours.

The crosslinked thermoplastic article can also have a specific gravity of from 0.80 g/cm³ to 1.20 g/cm³, from 0.80 g/cm³ to 1.00 g/cm³, from 0.80 g/cm³ to 0.98 g/cm³, 0.80 g/cm³ to 0.96 g/cm³, from 0.80 g/cm³ to 0.94 g/cm³, from 0.80 g/cm³ to 0.92 g/cm³, from 0.80 g/cm³ to 0.90 g/cm³, from 0.80 g/cm³ to 0.89 g/cm³, from 0.82 g/cm³ to 1.20 g/cm³, from 0.82 g/cm³ to 1.00 g/cm³, from 0.82 g/cm³ to 0.98 g/cm³, 0.82 g/cm³ to 0.96 g/cm³, from 0.82 g/cm³ to 0.94 g/cm³, from 0.82 g/cm³ to 0.92 g/cm³, from 0.82 g/cm³ to 0.90 g/cm³, from 0.82 g/cm³ to 0.89 g/cm³, from 0.84 g/cm³ to 1.20 g/cm³, from 0.84 g/cm³ to 1.00 g/cm³, from 0.84 g/cm³ to 0.98 g/cm³, 0.84 g/cm³ to 0.96 g/cm³, from 0.84 g/cm³ to 0.94 g/cm³, from 0.84 g/cm³ to 0.92 g/cm³, from 0.84 g/cm³ to 0.90 g/cm³, from 0.84 g/cm³ to 0.89 g/cm³, from 0.85 g/cm³ to 1.20 g/cm³, from 0.85 g/cm³ to 1.00 g/cm³, from 0.85 g/cm³ to 0.98 g/cm³, 0.85 g/cm³ to 0.96 g/cm³, from 0.85 g/cm³ to 0.94 g/cm³, from 0.85 g/cm³ to 0.92 g/cm³, from 0.85 g/cm³ to 0.90 g/cm³, from 0.85 g/cm³ to 0.89 g/cm³, from 0.86 g/cm³ to 1.20 g/cm³, from 0.86 g/cm³ to 1.00 g/cm³, from 0.86 g/cm³ to 0.98 g/cm³, 0.86 g/cm³ to 0.96 g/cm³, from 0.86 g/cm³ to 0.94 g/cm³, from 0.86 g/cm³ to 0.92 g/cm³, from 0.86 g/cm³ to 0.90 g/cm³, or from 0.86 g/cm³ to 0.89 g/cm³, including any and all ranges and subranges therein, when measured in accordance with ASTM D792.

In various embodiments, the crosslinked thermoplastic article has a tensile stress at 100% elongation (100% modulus) of from 100 psi to 1800 psi when measured in accordance with ASTM D412, die C. For example, the crosslinked thermoplastic article can have a tensile stress of from 100 psi to 1800 psi, from 100 psi to 1600 psi, from 100 psi to 1400 psi, from 100 psi to 1200 psi, from 100 psi to 1000 psi, from 100 psi to 800 psi, from 200 psi to 1800 psi, from 200 psi to 1600 psi, from 200 psi to 1400 psi, from 200 psi to 1200 psi, from 200 psi to 1000 psi, from 200 psi to 800 psi, from 400 psi to 1800 psi, from 400 psi to 1600 psi, from 400 psi to 1400 psi, from 400 psi to 1200 psi, from 400 psi to 1000 psi, from 400 psi to 800 psi, 600 psi to 1800 psi, from 600 psi to 1600 psi, from 600 psi to 1400 psi, from 600 psi to 1200 psi, from 600 psi to 1000 psi, or from 600 psi to 800 psi, including any and all ranges and subranges therein.

The crosslinked thermoplastic article of various embodiments further has a tensile strength at break of 200 psi to 2000 psi when measured in accordance with ASTM D412, die C of from 200 psi to 2000 psi. For example, the crosslinked thermoplastic article can have a tensile strength of from 200 psi to 2000 psi, from 200 psi to 1800 psi, from 200 psi to 1600 psi, from 200 psi to 1500 psi, from 400 psi to 2000 psi, from 400 psi to 1800 psi, from 400 psi to 1600 psi, from 400 psi to 1500 psi, from 600 psi to 2000 psi, from 600 psi to 1800 psi, from 600 psi to 1600 psi, from 600 psi to 1500 psi, from 800 psi to 2000 psi, from 800 psi to 1800 psi, from 800 psi to 1600 psi, from 800 psi to 1500 psi, from 1000 psi to 2000 psi, from 1000 psi to 1800 psi, from 1000 psi to 1600 psi, or from 1000 psi to 1500 psi, including any and all ranges and subranges therein.

In various embodiments, the crosslinked thermoplastic article has a tensile elongation at break of from 50% to 1,000% when measured in accordance with ASTM D412, die C. For example, the crosslinked thermoplastic article can have a tensile elongation at break of from 50% to 1,000%, from 50% to 900%, from 50% to 800%, from 50% to 700%, from 50% to 600%, from 50% to 500%, from 50% to 400%, from 100% to 1,000%, from 100% to 900%, from 100% to 800%, from 100% to 700%, from 100% to 600%, from 100% to 500%, from 100% to 400%, from 200% to 1,000%, from 200% to 900%, from 200% to 800%, from 200% to 700%, from 200% to 600%, from 200% to 500%, from 200% to 400%, from 300% to 1,000%, from 300% to 900%, from 300% to 800%, from 300% to 700%, from 300% to 600%, from 300% to 500%, or from 300% to 400%, including any and all ranges and subranges therein.

The crosslinkable thermoplastic composition of various embodiments described herein can be extruded or molded and crosslinked to form cured articles including, by way of example and not limitation, seals, gaskets, hoses, brackets, frame components for automobiles, building and construction components, trim, and the like. In some embodiments, the crosslinkable thermoplastic composition is extruded into a solid film or sheet. In particular embodiments, the crosslinkable thermoplastic composition is extruded into a film or sheet having a thickness of from 0.1 mm to 2 mm, or from 0.2 mm to 1 mm, and cured. The resultant sheet exhibits excellent properties, including a smooth surface and good processability.

The general inventive concepts have been described above both generally and with regard to various specific aspects. Although the general inventive concepts have been set forth in what are believed to be exemplary illustrative aspects, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and does not limit the scope of the general inventive concepts described herein.

### Example 1

From 30-40 wt. % of each of an ethylene-based elastomer having a density of 0.866 g/cm³ and a propylene-based elastomer having a density of 0.862 g/cm³ were blended with from 20 wt. % to 30 wt. % of a recycled HDPE having a specific gravity of 0.960 g/mL and a crystallinity of greater than 40% in a twin screw extruder at a temperature of 380° F. Approximately 0.18 wt. % dicumyl peroxide and about 1.8 wt. % of a vinyl silane were also added to the twin screw extruder with the polymers. The ingredients were mixed at 350 rpm. Weight percentages are based on a total weight of the reaction mixture. The resultant crosslinkable polymeric material was extruded and pelletized.

Durometer (measured in accordance with ASTM D2240), specific gravity (measured in accordance with ASTM D792), tensile strength at break (measured in accordance with ASTM D412, die C), tensile elongation at break (measured in accordance with ASTM D412, die C), and tensile stress at 100% elongation (measured in accordance with ASTM D412, die C) were measured for the crosslinkable polymeric material. The values are reported in Table 1.

With the pelletized crosslinkable polymeric material, 3 wt. % of a crosslinking catalyst was added to the hopper of an injection molding machine at 400° F. and mixed at 120 rpm. Following mixing, the material injection molded into plaques. Some plaques were reserved for testing, and other plaques were cured at 70° C. and 90% relative humidity for 24 hours. Durometer, specific gravity, compression set, tensile strength at break, tensile elongation at break, and tensile stress at 100% elongation were measured for the various plaques (cured and uncured (reported as crosslinkable polymeric material in Table 1 below)). Compression set was measured at 150° C. for 22 hours, in accordance with ASTM D395B (25% deflection). The values are reported in Table 1.

| | Crosslinkable | Crosslinked |
|---|---|---|
| | Polymeric Material | Article |
| Hardness (Shore A; 10 s delay) | 69 | 76 |
| Specific Gravity | 0.88 | 0.88 |
| 100% modulus (psi) | 484 psi | 626 psi |
| Tensile Strength at break (psi) | 787 psi | 1197 psi |
| Tensile elongation (%) | 537% | 355% |
| Compression Set | — | 19% |

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A crosslinkable material comprising:
10 wt. % to 80 wt. % of a silane-grafted ethylene-based elastomer, based on a total weight of the crosslinkable polymer material;
10 wt. % to 80 wt. % of a silane-grafted propylene-based elastomer, based on a total weight of the crosslinkable polymer material; and
10 wt. % to 40 wt. % of a silane-grafted polyethylene homopolymer, based on a total weight of the crosslinkable polymer material.

2. The crosslinkable polymer material of claim 1, wherein the silane-grafted ethylene-based elastomer is formed from an ethylene-alpha olefin copolymer.

3. The crosslinkable polymer material of claim 1, wherein the silane-grafted ethylene-based elastomer is formed from an ethylene-based elastomer having a density of from 0.86 g/cm³ to 0.90 g/cm³.

4. The crosslinkable polymer material of claim 1, wherein the silane-grafted propylene-based elastomer is formed from a propylene-alpha olefin copolymer.

5. The crosslinkable polymer material of claim 1, wherein the silane-grafted propylene-based elastomer is formed from a propylene-based elastomer having a density of from 0.85 g/cm³ to 0.90 g/cm³.

6. The crosslinkable polymer material of claim 1, wherein the silane-grafted polyethylene homopolymer is formed from a polyethylene homopolymer having a weight average molecular weight of from 10,000 g/mol to 500,000 g/mol.

7. (canceled)

8. (canceled)

9. The crosslinkable polymer material of claim 1, wherein the crosslinkable polymer material has a hardness of 50 Shore A to 50 Shore D.

10. The crosslinkable polymer material of claim 1, wherein the silane-grafted ethylene-based elastomer, the silane-grafted propylene-based elastomer, and the silane-grafted polyethylene homopolymer are prepared by reacting an ethylene-based elastomer, a propylene-based elastomer, and a polyethylene homopolymer with a vinyl silane and an organic peroxide.

11-14. (canceled)

15. The crosslinkable polymer of claim 1, wherein the silane-grafted ethylene-based elastomer, the silane-grafted propylene-based elastomer, and the silane-grafted polyethylene homopolymer each comprise a silane moiety having a functional group capable of crosslinking the corresponding silane-grafted ethylene-based elastomer, silane-grafted propylene-based elastomer, and silane-grafted polyethylene homopolymer in the presence of a moisture-cure crosslinking catalyst.

16. A crosslinkable thermoplastic composition comprising the reaction product of:
10 wt. % to 80 wt. % of a silane-grafted ethylene-based elastomer, based on a total weight of the crosslinkable thermoplastic composition;
10 wt. % to 80 wt. % of a silane-grafted propylene-based elastomer, based on a total weight of the crosslinkable thermoplastic composition;
10 wt. % to 40 wt. % of a silane-grafted polyethylene homopolymer, based on a total weight of the crosslinkable thermoplastic composition; and
0.5 wt. % to 8 wt. % of a crosslinking catalyst, based on a total weight of the crosslinkable thermoplastic composition.

17. The crosslinkable thermoplastic composition of claim 16, wherein the crosslinking catalyst comprises an organic base, a carboxylic acid, a metallic stearate, an organometallic compound, or a combination thereof.

18. The crosslinkable thermoplastic composition of claim 16, wherein the crosslinkable thermoplastic composition has a Shore A hardness of from 50 to 100 after curing.

19. The crosslinkable thermoplastic composition of claim 16, wherein the crosslinkable thermoplastic composition has a compression set of 5% to 50% at 150° C. after curing.

20. The crosslinkable thermoplastic composition of claim 16, wherein the silane-grafted ethylene-based elastomer is formed from an ethylene-alpha olefin copolymer.

21. The crosslinkable thermoplastic composition of claim 16, wherein the silane-grafted ethylene-based elastomer is formed from an ethylene-based elastomer having a density of from 0.86 g/cm³ to 0.90 g/cm³.

22. The crosslinkable thermoplastic composition of claim 16, wherein the silane-grafted propylene-based elastomer is formed from a propylene-alpha olefin copolymer.

23. The crosslinkable thermoplastic composition of claim 16, wherein the silane-grafted propylene-based elastomer is formed from a propylene-based elastomer having a density of from 0.85 g/cm³ to 0.90 g/cm³.

24-29. (canceled)

30. A method of forming a crosslinkable silane-grafted polyolefin composition comprising:
reacting:
10 wt. % to 80 wt. % of an ethylene-based elastomer;
10 wt. % to 80 wt. % of a propylene-based elastomer;
10 wt. % to 40 wt. % of a polyethylene homopolymer;
0.5 wt. % to 5 wt. % of a vinyl silane; and
0.05 wt. % to 1.5 wt. % of an organic peroxide.

31. (canceled)

32. The method of claim 30, wherein the ethylene-based elastomer has a density of from 0.86 g/cm³ to 0.90 g/cm³.

33. (canceled)

34. The method of claim 30, wherein the propylene-based elastomer has a density of from 0.85 g/cm³ to 0.90 g/cm³.

35-46. (canceled)
